(19) United States
(12) Patent Application Publication
(10) Pub. No.: US 2026/0201744 A1
(43) Pub. Date: Jul. 16, 2026

(54) WINDOW COVERINGS ARTICLES AND METHODS OF MANUFACTURING THE SAME

(71) Applicant: Paralign LLC, Plano, TX (US)

(72) Inventors: Benjamin Spencer, Oak Harbor, WA (US); John Brian Gerich, Seattle, WA (US)

(21) Appl. No.: 19/134,711

(22) PCT Filed: Dec. 1, 2023
(86) PCT No.: PCT/US23/82206

§ 371 Date: May 30, 2025

Related U.S. Application Data
(60) Provisional application No. 63/429,526, filed on Dec. 1, 2022.

(51) Int. Cl. E06B 9/264; E06B 9/24; E06B 9/34

(52) U.S. Cl. CPC E06B 9/264; E06B 9/34; E06B 2009/2429

(57) ABSTRACT

Window covering articles embodiments that include a sheet of flexible material along a first axis but inflexible along a second axis, including a plurality of rigid strips and an overlapping sheet of flexible material. Also a method for creating a window coverings including steps of providing a first layer of flexible material, attaching a second layer of rigid material to the sheet of flexible material, and fracturing the second layer of rigid material into a plurality of rigid strips, but leaving the second layer of flexible material intact while preserving attachment of the plurality of rigid strips to the sheet of flexible material. The fracturing the second layer of rigid material into a plurality of rigid strips may result in the strips being parallel-aligned to each other.

### CROSS-REFERENCE TO RELATED APPLICATIONS

This application claims priority and benefit to U.S. Provisional Application No. 63/429,526, filed on Dec. 1, 2022, and titled “Window Coverings Articles and Methods of Manufacturing the Same,” the contents all of which are incorporated by reference herein as though set forth in their entirety.

### FIELD OF USE

This disclosure relates to the field of window coverings, shades, and/or blinds, and methods of manufacturing the same.

### BACKGROUND

Window coverings include a wide range of products designed to control the passage of solar radiation and views through windows, doors, curtain walls, porticos, and other openings in residential, commercial, and institutional structures. They provide services ranging from daylighting, to the modulation of solar heat gain, to privacy, to the protection of interior furnishings from UV degradation. They can enhance the aesthetics, sensory/tactile qualities, acoustics, and other characteristics of interior and exterior spaces. They come in a wide range of forms, including roller shades, roman shades, banded shades, vertical shades, honeycomb shades, and more. Despite this variety, the design and manufacture of window covering products remains imperfect, often involving trade-offs between structure, function, aesthetics, and other qualities. Aspects of their performance such as their ability to permit or block light, provide views or privacy, retract and extend, etc. are limited by the properties of the materials of which they are comprised and the processes involved in their manufacture.

### SUMMARY OF THE DISCLOSURE

The following presents a simplified overview of example embodiments in order to provide a basic understanding of some aspects of the invention. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The disclosure also describes improving the performance and manufacture of window covering products. Among other things, described herein are novel approaches for incorporating rigid/tough sheet material(s) into window covering screens.

Described here are embodiments of window covering articles for preventing at least some light from passing through a window. Some window covering article embodiments include a sheet of flexible material extending along a first axis and a second axis and conformed to the shape of a window so as to cover at least a portion of the window. The window covering article may be flexible along the first axis and but inflexible along the second axis.

Some window covering article embodiments also include a plurality of rigid strips. In some examples, each of the plurality of rigid strips is adjacent to at least one other of the plurality of rigid strips. In some examples, the sheet of flexible material overlaps the plurality of rigid strips. Some window covering article embodiments also include a plurality of light-permitting perforations between at least two adjacent rigid strips of the plurality of rigid strips.

In some window covering article embodiments, at least a portion of some of the plurality of rigid strips is not adjoining to any of the other of the plurality of rigid strips. In some examples, the plurality of rigid strips are attached to the sheet of flexible material. In some examples, each of the plurality of rigid strips has a length and a width, wherein the length is greater than the width. In some examples, the plurality of strips are parallel to one another along the length of each of the plurality of rigid strips. In some examples, the first axis is perpendicular to the second axis, and the plurality of strips are parallel to one another along the second axis. In some embodiments, the first axis corresponds to a vertical axis and the second axis corresponds to a horizontal axis, and wherein the window covering article is rollable together along the first axis. Some window covering article embodiments include a plurality of joints. In some examples, at least one of the plurality of joints is between each of the adjacent plurality of rigid strips. In some examples, each of the plurality of joints is bendable so that the window covering article rolls together along the first axis. In some examples, each of the plurality of joints is adjoining to two adjacent rigid strips of the plurality of rigid strips.

In some window covering article embodiments, the sheet of flexible material further includes a plurality of perforations. In some examples, the sheet of flexible material is at least one of transparent, semitransparent, translucent, or opaque.

In some window covering article embodiments, the plurality of rigid strips and the sheet of flexible material together form a screen, and further include one or more light-permitting areas in the screen. In some window covering article embodiments, the plurality of rigid strips include a first plurality of rigid strips, and the sheet of flexible material comprises a first sheet of flexible material, and the screen comprises a first screen. Some window covering article embodiments further include a second screen comprising a second sheet of flexible material overlapping a second plurality of rigid strips. In some examples, the second screen includes one or more light-permitting areas, and the window covering article is configured to align the first screen in parallel with the second screen.

Some such window covering article embodiments are configured to align the one or more light-permitting areas of the first screen with the one or more light-permitting areas of the second screen to increase light through the aligned one or more light-permitting areas of the first screen and one or more light-permitting areas of the second screen. Some such window covering article embodiments are also configured to dis-align the one or more light-permitting areas of the first screen with the one or more light-permitting areas of the second screen to decrease light through the aligned one or more light-permitting areas of the first screen and one or more light-permitting areas of the second screen. In some embodiments, the first screen and the second screen form separate portions of the same screen, folded over.

Also described herein are method embodiments for creating a window covering article. Some method embodiments may include the step of providing a first layer of flexible material. Some method embodiments may include the step of attaching a second layer of rigid material to the sheet of flexible material. In some method embodiments the second layer of rigid material is attached to the first layer of flexible material.

Some method embodiments may include the step fracturing the second layer of rigid material into a plurality of rigid strips. Some method embodiments may involve leaving the second layer of flexible material intact while preserving the attachment of the plurality of rigid strips to the sheet of flexible material, to create the window covering article. In some method embodiments, the step the fracturing includes fracturing the second layer of rigid material into a plurality of rigid strips that are parallel-aligned to each other.

In some method embodiments, the step of attaching the second layer of rigid material to the first layer of flexible material results in a sheet of materials with two layers. In some method embodiments, the fracturing includes at least one of scoring or cutting entirely through the sheet of materials. Some method embodiments may include the step of cutting at least one of the second layer of rigid material and the first layer of flexible material in a pre-determined pattern. In some method embodiments, the pre-determined pattern leaves at least some light-permitting areas through which light passes through at least some areas of the sheet of flexible material corresponding to the at least some light-permitting areas. In some method embodiments the attaching the second layer of rigid material to the first layer of flexible material includes adhering the second layer of rigid material to the first layer of flexible material. Some method embodiments include the step of conforming the window covering article to the dimensions of a window

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. In certain instances, details that are not necessary for an understanding of the disclosure or that render other details difficult to perceive may have been omitted.

FIG. 1A is a window covering embodiment, in accordance with some aspects of the disclosure.

FIG. 1B illustrates a portion of the window covering embodiment of FIG. 1A, in accordance with some aspects of the disclosure.

FIG. 1C illustrates a side view of the window covering embodiment of FIG. 1B, in accordance with some aspects of the disclosure

FIG. 2A illustrates another window covering embodiment, in accordance with some aspects of the disclosure.

FIG. 2B illustrates the window covering embodiment of FIG. 2A, in accordance with some aspects of the disclosure.

FIG. 2C is a close-up, cutaway side view of the window covering embodiment of FIG. 2A, in accordance with some aspects of the disclosure.

FIG. 3A is a front view of a window covering embodiment, in accordance with some aspects of the disclosure.

FIG. 3B is a back view of a window covering embodiment, in accordance with some aspects of the disclosure.

FIG. 4A is a front view of a window covering embodiment, in accordance with some aspects of the disclosure.

FIG. 4B is a back view of a window covering embodiment, in accordance with some aspects of the disclosure.

FIG. 5 illustrates a window covering embodiment in an environment of use, in accordance with some aspects of the disclosure.

FIG. 6 illustrates the window covering embodiment of FIG. 5 in an environment of use, in accordance with some aspects of the disclosure.

FIG. 7 illustrates the window covering embodiment of FIG. 5 in an environment of use, in accordance with some aspects of the disclosure.

FIG. 8 illustrates a window covering embodiment, in accordance with some aspects of the disclosure.

FIG. 9 illustrates the window covering embodiment of FIG. 8, in accordance with some aspects of the disclosure.

FIG. 10 illustrates the window covering embodiment of FIG. 8, in accordance with some aspects of the disclosure.

FIG. 11 illustrates a window covering embodiment, in accordance with some aspects of the disclosure.

FIG. 12 illustrates a window covering embodiment, in accordance with some aspects of the disclosure.

FIG. 13 illustrates a window covering embodiment, in accordance with some aspects of the disclosure.

FIG. 14 illustrates a back side of a window covering embodiment, in accordance with some aspects of the disclosure.

FIG. 15 illustrates a front side of the window covering embodiment of FIG. 14, in accordance with some aspects of the disclosure.

FIG. 16 illustrates a window covering embodiment, in accordance with some aspects of the disclosure.

FIG. 17 illustrates a window covering embodiment, in accordance with some aspects of the disclosure.

FIG. 18 also illustrates the window covering embodiment of FIG. 17, in accordance with some aspects of the disclosure.

FIG. 19 also illustrates the window covering embodiment of FIG. 17, in accordance with some aspects of the disclosure.

FIG. 20 illustrates a partically cutaway view of a window covering embodiment, in accordance with some aspects of the disclosure.

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

It is to be noted that terms “upper”, “lower”, “front”, “rear”, and the like are made with reference to the accompanying drawings, or in the state that the battery pack configurations are integrated to the vehicle spaceframe 1, which is in a steady state for running, in which travelling direction is mentioned as “front” or “forward”.

Articles and method embodiments of the disclosure may improve the performance and manufacture of window covering products, such as roller shades and banded shades. In some aspects, this may be accomplished by deploying novel approaches to the incorporation of rigid/tough sheet material(s) to shade fabrics/flexible screens. In some examples, such approaches may provide benefits including, but not limited to streamlined manufacture, increased durability, improved flatness/shape retention, and improved light penetration and views. Details and improvements of the invention's application process and configuration may vary depending on the particular window covering type/product, and may include, but are not limited to, those described in the sections below.

Some aspects of the disclosure may improve the performance and manufacture of window covering products such as roller shades and banded shades by deploying a novel approach to the incorporation of rigid/tough material(s) into flexible screens. Said application process and configuration may provide benefits including, but not limited to: (1) streamlined manufacture, (2) increased durability, (3) flatness/shape retention, and (4) and improved light penetration and views.

For example, some embodiments contemplated herein may be similar in some aspects to roller shades. Roller/solar shades are a window covering product that block or permit the transmission of light and views through window openings, and provide privacy in interior spaces. They generally include a screen and a roller mechanism. When the screen is unrolled from the roller mechanism, it partially or fully extends to prevent light and view from entering through a window opening. When the screen rolls up on the roller mechanism, it partially or fully retracts and allows light and view to enter through a window opening.

Embodiments contemplated herein may have sheets or screens made from flexible materials (e.g., fabric), which retracts and extends on a roller mechanism to modulate the passage of light and views through a window opening, but may improve upon roller shades in various ways. For example, incorporation of rigid/tough materials that may increase overall screen flatness or form, and/or otherwise increase resistance to deformation when hanging or stretched out.

Some embodiments contemplated herein may also resemble banded/zebra/transitional/layered/paralign shades, which is a window covering product consisting of a long screen with alternating bands of substantially opaque areas and light/view permitting areas folded over or layered one or more times. Banded shades can be folded or layered and retracted/rolled into a compact cylinder. Light-permitting areas of banded shades are typically made of mesh or sheer fabric. The mesh or sheer fabric has a degree of opacity which limits the light penetration of these areas, especially in direct sunlight. The layering of banded shades compounds this opacity and prevents banded shades from providing clear views.

Some embodiments contemplated herein in may be a window covering consisting of a sheet or screen, with alternating bands of substantially opaque areas and light/view permitting areas, folded over or layered one or more times. By shifting the relative alignment of the opaque bands/areas and light/view permitting bands/areas of the screen's layers, users can manipulate light and view transparency of the shades. Aspects of the second embodiment may improve upon banded shades, e.g., by incorporating rigid/tough materials that: (1) allow for the removal/exclusion of the majority of the mesh or other materials in the screen's light/view permitting bands, thereby increasing the transparency of the screen's light/view permitting bands and providing clearer views; and (2) increase overall screen flatness or other form and resistance to deformation when hanging or stretched out.

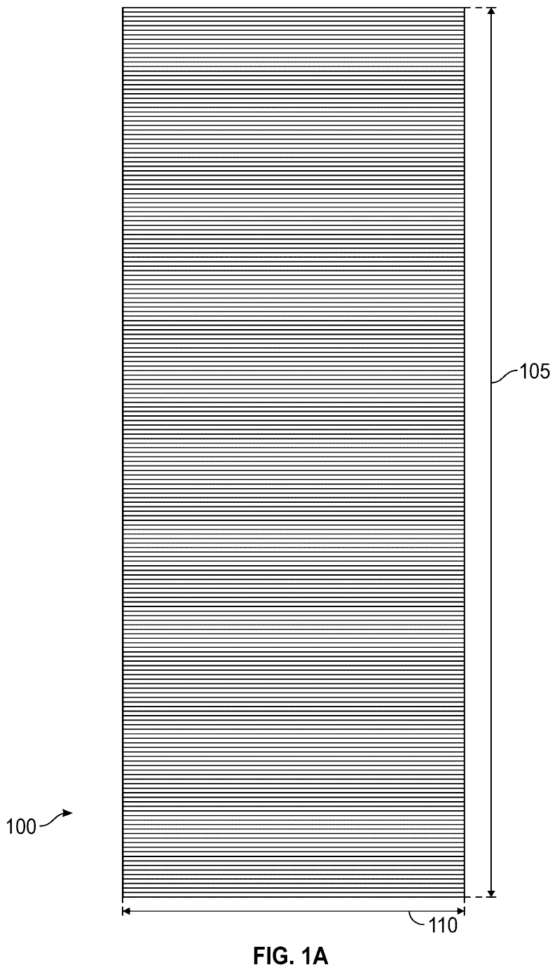

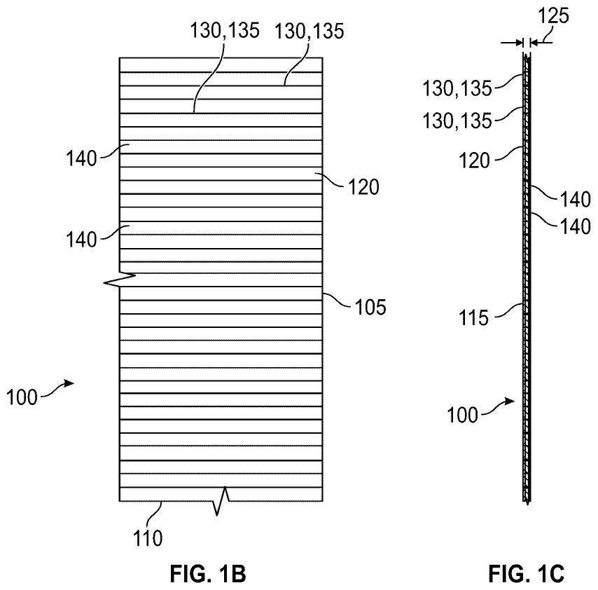

FIG. 1A illustrates a window covering embodiment, in accordance with some aspects of the disclosure. The window covering embodiment 100 may be flexible along a vertical or first axis 105. Such flexibility may be the result of a flexible material (e.g., fabric, non-woven, film, paper or other flexible sheet material (“fabric”)) as described in further detail herein. The window covering embodiment 100 may be inflexible or rigid along a horizontal or second axis 110. The rigidity may be the result being made of inflexible, solid, and/or rigid material. In some embodiments, and as shown, the first axis 105 may be perpendicular to the second axis 110, and the plurality of strips are parallel to one another along the second axis 110. Rigid material, in some examples, may provide stiffness along the axis perpendicular to a screen's direction of retraction. Flexible material, in some examples, may provide flexibility along the axis that runs parallel to the screen's direction of retraction.

FIG. 1B illustrates a portion of the window covering embodiment 100 of FIG. 1A, in accordance with some aspects of the disclosure. FIG. 1C illustrates a side view of the window covering embodiment 100 of FIG. 1B, in accordance with some aspects of the disclosure.

The window covering embodiment 100 may include a first layer 115 that is flexible along a vertical or first axis 105, and a second layer 120 that is rigid or inflexible along the horizontal or second axis 110. Together, the first layer 115 and the second layer 120 may form a sheet 125. For example, in some embodiments, the first layer 115 may be laminated with, adhered (e.g., using glue), bonded with, or attached to the second layer 120.

In some embodiments, the second layer 120, or a sheet of rigid material, may be attached to the first layer 115 or sheet of flexible material by lamination. In some embodiments, the second layer 120 or sheet of rigid material may include at least one of bamboo veneer (e.g., microlaminate), other wood veneer, laminated wood, fibreglass sheet, plastic sheet, or the like, or any combination thereof. In some embodiments, the second layer 120 or sheet of rigid material may have a thickness less than 0.25 inches and, in some examples, less than 1.5 mm.

Relatedly, aspects discussed herein may involve modifying the structural characteristics through the incorporation of rigid materials that provide stiffness along the axis perpendicular to the screen's direction of retraction (parallel to the axis of the screen's opaque and light/view permitting areas/bands), and flexibility along the axis running parallel to the screen's direction of retraction. In this manner, some embodiments described herein may: (1) provide increased rigidity/toughness along the axis parallel to a screen's opaque and light/view permitting areas/bands without compromising the flexibility of the screen along the axis perpendicular the opaque and light/view permitting bands, co-planar to the screens, and parallel to the direction of retraction; (2) flatten the faces of, and straighten the edges of, a screen's opaque bands; (3) assist in maintaining the screen's overall flatness when hanging or extended; and (4) allow for the exclusion of the majority of the mesh, fabric and/or other materials typically found in certain other prior art shades' (e.g., banded shades') light/view permitting areas/bands, thus improving the transparency of banded shades. In some embodiments, such rigidity may also allow or facilitate opaque areas of banded shade screens to remain flat (without bending or waviness) as they span across the openings/transparent areas of the screen without the mesh found in typical banded shades.

Some article embodiments for controlling light and visibility therethrough, such as window covering embodiment 100 may include: a first layer 115 or sheet of flexible material; a second layer 120 or sheet of rigid material, attached to the first layer 115 of sheet of flexible material; wherein the second layer 120 or sheet of rigid material may have a proximal end and a distal end along a first axis (e.g., vertical, or horizontal). In some examples the second layer 120 or sheet of rigid material may include at least one plurality of strips 140 adjacent but unconnected to one another extending from the proximal end to the distal end.

In some embodiments, the first layer 115 may be a piece of fabric. In some examples, the first layer 115 may be opaque; in other examples, the first layer 115 may be transparent or translucent. In some embodiments, the second layer 120 may be wood veneer. In some embodiments, the sheet 125 of the window covering embodiment 100 may be scored at predetermined scoring locations 130. In some embodiments, additionally or alternatively, the sheet 125 of the window covering embodiment 100 may be perforated at predetermined perforation locations 135. In some embodiments, the sheet 125 of the window covering embodiment 100 may be both scored at predetermined locations 130 and perforated at some of the same locations 130, 135 that were scored. In some embodiments, the sheet 125 of the window covering embodiment 100 may be scored at some predetermined locations 130 and perforated at other locations 135.

In some embodiments, the scoring may constitute cutting all the way through the second layer 120, but not cutting through, or all the way through, the first layer 115. In some embodiments, the perforating may constitute cutting all the way through the second layer 120 and cutting all the way through the first layer 115. In some embodiments, the scoring may cut all the way through the second layer 120 at predetermined locations 130, and the perforating may additionally cut all the way through the first layer 115 at some of the predetermined locations 130, 135. In some examples, the predetermined locations 130 for the scoring may constitute scoring lines and/or perforation lines 130, 135.

In some examples, the predetermined locations 130 of the scoring may be at linearly parallel locations 130 of the sheet 125. In some examples, the predetermined locations 130 of the scoring may not be at the same linearly parallel locations 130 of the sheet 125. In some examples, the predetermined locations 130 of the scoring may be at equidistant, linearly parallel locations 130 of the sheet 125. In some examples, the scoring. In some embodiments, the scoring all the way through the second layer 120 may result in separate and distinct pieces of the second layer 120. In some embodiments, such separate and distinct pieces of the second layer 120 may be parallel strips 140. For example, in some embodiments where the first axis 105 is perpendicular to the second axis 110, the plurality of strips 140 may be parallel to one another along the second axis. In some embodiments, such parallel strips 140 may be adjacent to each other (e.g., each parallel strip 140 may be adjacent to at least one other parallel strip 140).

In some examples, the predetermined locations 135 of the perforating may be, or may not be, at linearly parallel locations 135 of the sheet 125. In some examples, the predetermined locations 135 of the perforating may be at some of the same linearly parallel locations 130 as the scoring. In some examples, the predetermined locations 135 of the perforating may not be at the same linearly parallel locations 130 of the sheet 125. In some examples, the predetermined locations 135 of the perforating may occur at a plurality of perforations having the same vertical coordinate (which may not necessarily have the same horizonal coordinates of one or more perforations at another vertical coordinate). In some examples, the predetermined locations 135 of the perforating may occur at a plurality of perforations having different vertical coordinates. In some embodiments, the perforated sheet 125 of the window covering embodiment 100 may be scored at some predetermined locations 130 and perforated at other locations 135.

Some embodiments may incorporate aspects of roller shades in that it may include a screen or the first layer 115 made from the flexible material, which is retractable and extensible via a roller mechanism to modulate the passage of light and views through a window opening. And some aspects described herein may improve upon roller shades through the incorporation of rigid/tough materials, which may for example, increase overall screen flatness and resistance to deformation and damage when the roller shade is hanging or extended.

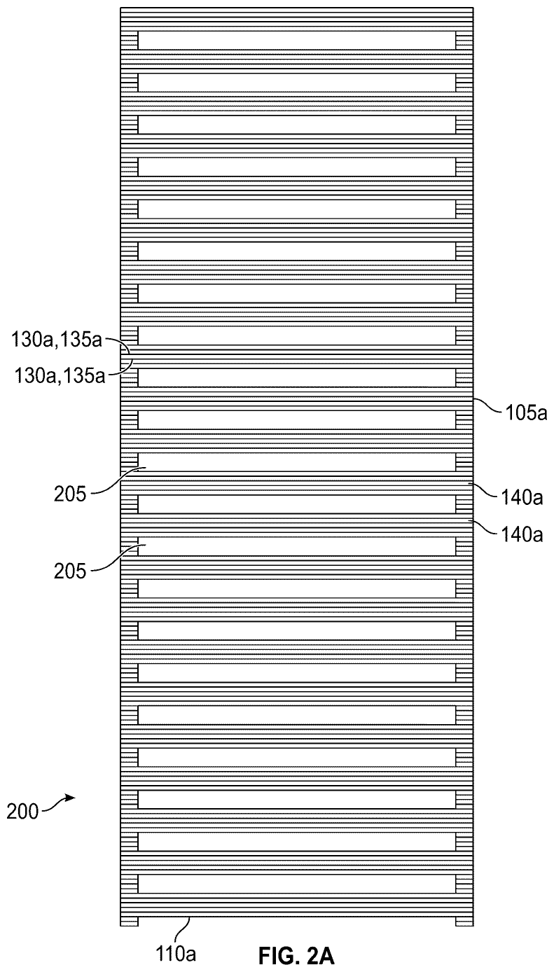

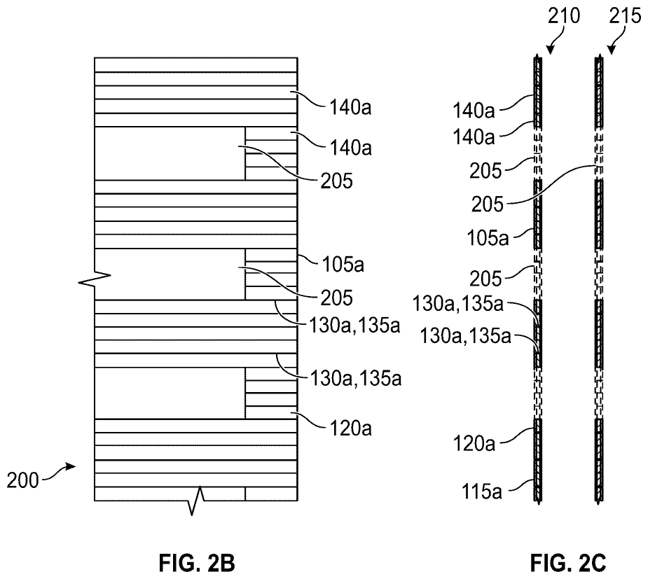

FIG. 2A illustrates another window covering embodiment 200, in accordance with some aspects of the disclosure. The window covering embodiment 200 may be similar in some aspects to the window covering embodiment 100 of FIGS. 1A-1C. For example, the window covering embodiment 200 may have a first flexible axis 105a and a second rigid axis 110a. Also, the window covering embodiment 200 may be scored and/or perforated and therefore have score lines 130a and/or perforation lines 135a. In addition, the window covering embodiment 200 may have one or more open bands 205, which may be much larger areas than the individual perforations or perforation lines 135a. FIG. 2A may a front elevation view of the window covering embodiment 200, and in some embodiments may resemble a banded shade.

For example, embodiment 200 may be similar to banded shades in that it may be a window covering consisting of one or more sheets or screens (including e.g., first layer 115a and the second layer 120a), with alternating bands 140a, 205 (which may be substantially opaque areas 140a and light/view permitting areas 205 respectively). In addition, in some embodiments, one or more layers or screens may shift in position or spacing relative to a direction that is normal to the plane of the layers or screens. This additional mobility may allow for enhanced control over the passage of light and view.

FIG. 2B is a close-up view of the window covering embodiment 200 of FIG. 2A, in accordance with some aspects of the disclosure. FIG. 2C is a close-up, cutaway side view of the window covering embodiment 200 of FIG. 2A, in accordance with some aspects of the disclosure.

In some examples, the score lines 130a (and potentially in conjunction with the perforation lines 135a to some extent) of the window covering embodiment 200 may separate strips 140a into opaque bands 140a, while open bands 205 may be transparent—e.g., from the absence of the first layer 115a and the second layer 120a at such locations/areas. In the some embodiments, the open bands 205 may be configured for permitting light and/or viewing therethrough, in a greater amount than at the perforation lines 135a.

In some embodiments, as shown in FIG. 2C, the window covering embodiment 200 may include a first sheet 210 and a second sheet 215. In some embodiments the first sheet 210 and second sheet 215 may constitute the same sheet (e.g., making the first sheet 210 a first portion of the sheet and the second sheet 215 a second portion of the sheet), but having e.g., double (or more than double) the length of the first sheet 210, with the half of the length folded over on itself. Thus the one or more sheets 210, 214, may be folded over or layered one or more times. And by shifting the relative alignment of the opaque bands/areas and light/view permitting bands/areas of the screen's layers, in a direction that is co-planar with the screens, users may manipulate light and view transparency of the shades. More specifically, the first sheet 210 and the second sheet 215 may be parallel aligned along the first or vertical axis 105a, and may be movable/shiftable with respect to one another along that axis. In some embodiments, the open bands 206 may consist of translucent material rather than no material.

In the example shown, the first sheet 210 and the second sheet 215 each have open bands 205, which in some configurations may be aligned (and which may be unaligned or partially aligned in other configurations). In some embodiments, when the open bands 205 of the first sheet 210 and the second sheet 215 are aligned to form viewing areas in the window covering embodiment 200, a user may be able to see through the open bands 205 without any distortions from the first sheet 210 and/or second sheet 215. In some embodiments, when the open bands 205 of the first sheet 210 and the second sheet 215 are completely aligned, so that the open bands 205 of the first sheet 210 do not overlap with the open bands 205 of the second sheet 215, a user may be unable to see through the open bands 205. In some embodiments, when the open bands 205 of the first sheet 210 and the second sheet 215 are partially aligned, so that the open bands 205 of the first sheet 210 partly overlap with the open bands 205 of the second sheet 215, a user may be unable to see through some portion of the open bands 205. Thus, the first sheet 210 and the second 215 may be configured to collaboratively engage in two or more settings or configurations that result in differing degrees of viewing and light selection. Some such configurations may be unachievable through prior art window coverings, and may be facilitated through incorporation of the rigid second layer 120a. Thus, some aspects of window covering embodiment 200 and/or other embodiments described herein may improve upon banded shade screens by modifying structural characteristics so as to allow for an increase in the transparency of the screens'light/view permitting areas/bands and provide clearer views.

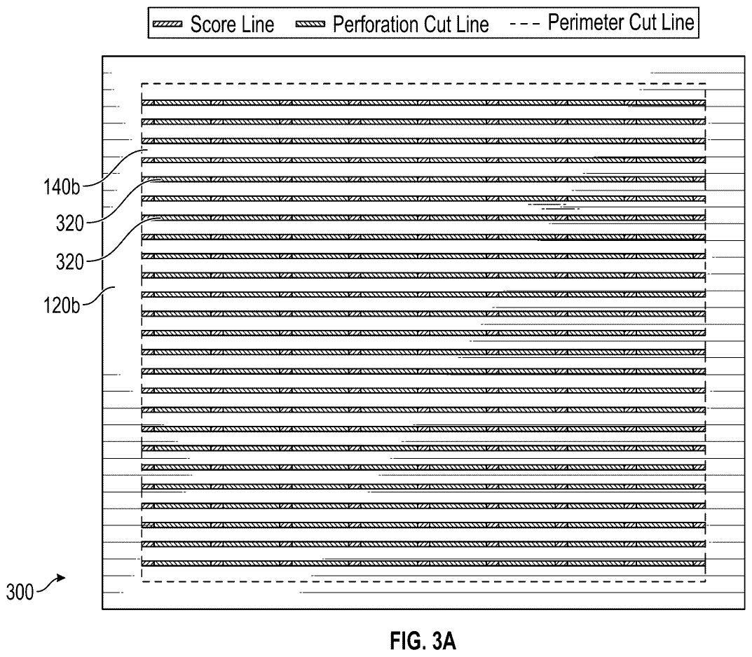

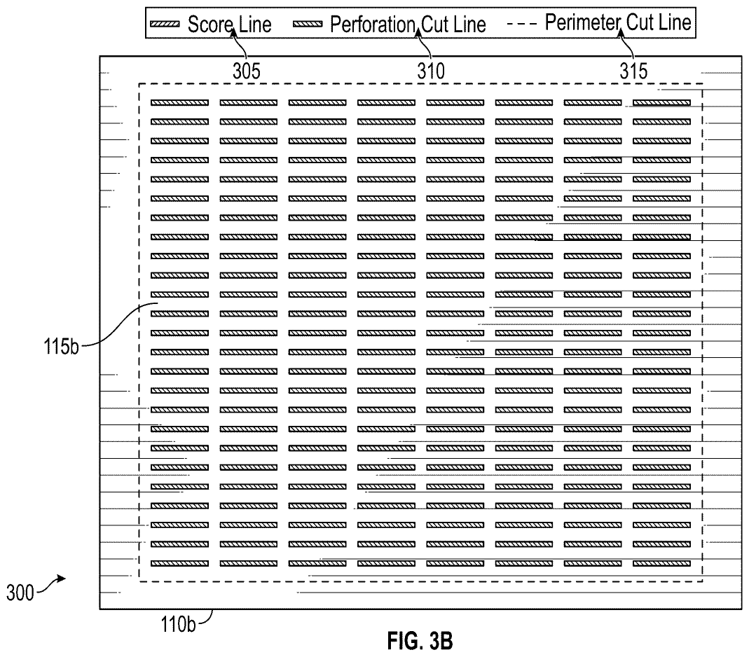

FIG. 3A is a front view of a window covering embodiment 300, in accordance with some aspects of the disclosure. For example, the front view of the embodiment 300 shown may show first the second layer 120b thereof. FIG. 3B is a back view of a window covering embodiment 300, in accordance with some aspects of the disclosure. For example, the back view of the embodiment 300 shown may show first the first layer 115b thereof.

The window covering embodiment 300 may be similar in some aspects to window covering embodiments 100, 200. The window covering embodiment 300 may have score lines 305 and/or perforation lines 310, and may additionally have perimeter cut lines 315.

In some embodiments, the score lines 305 may be where cuts were made to/through the second layer 120b (e.g., a wood veneer) but not all the way through to the first layer 115b (e.g., a fabric or sheet of flexible material). In the example shown in FIG. 3A, the score lines 305 may extend the entire distance of the perimeter cut lines 315, from end to end. For example, the wood strip may be cut due to a single pass all the way across from left to right, without a break in the cut. In some embodiments, and as shown, the perforation lines 310 and/or the cut lines 315 and/or the score lines 305 may run along a horizontal axis 110b. In some examples, such lines 305, 310, 315 may run parallel to the grain on the exposed front face of a 3-ply, cross-laminated bamboo veneer.

In some embodiments, such scoring at the score lines may form strips 140b of the second layer 120b of rigid materials. And the score lines may additionally form a slit 320 or series/plurality of slits 320 in between the strips 140b. In some embodiments, not shown, the slits 320 between the strips 140b may be wider.

In such embodiments, as shown in FIG. 3A, the first layer 115b may be visible at the score lines 305 from the front view of the window covering embodiment 300, at locations where there are not also perforations (e.g., showing a separate layer of fabric behind wood veneer/rigid strips). That is, at the perforation lines 310, which in the example shown may match up with the score lines 305, a series or plurality of perforations (or a single perforation) may be staggered at predetermined (e.g., intermittent) locations and/or in predetermined patterns.

As shown in FIG. 3B and from the back view of the embodiment 300, the score line 305 may not cut all the way through the first layer 115b (which may be e.g., fabric). On the other hand, in the embodiment 300 shown, the perforation lines 310 may be cut through both the first layer 115b and the second layer 120b. For example, in some embodiments, the perforation lines 310 may be cut through both 3-ply cross-laminated bamboo and through fabric

The score lines 305, perforation cut lines 310, and perimeter cut lines 315, and strips 140b may have varying dimensions and patterns. For example, the perimeter cut lines 315, in some embodiments, may have a length/width of about 245 mm and a height of about 195 mm. And in some embodiments, the score lines 305 may have about the same width/length as the perimeter cut lines 315, and may be vertically separated by about 7.5 mm. In addition, the perforation cut lines 310 may be along the same score lines 305 but be staggered so as to not cut the entire length of the score lines 305. For example, as shown in FIGS. 3A and 3B, the perforation cut lines 310 may be repeated along the length of the score lines 305 with each perforation being about 25 mm and each space between perforations being about 5 mm.

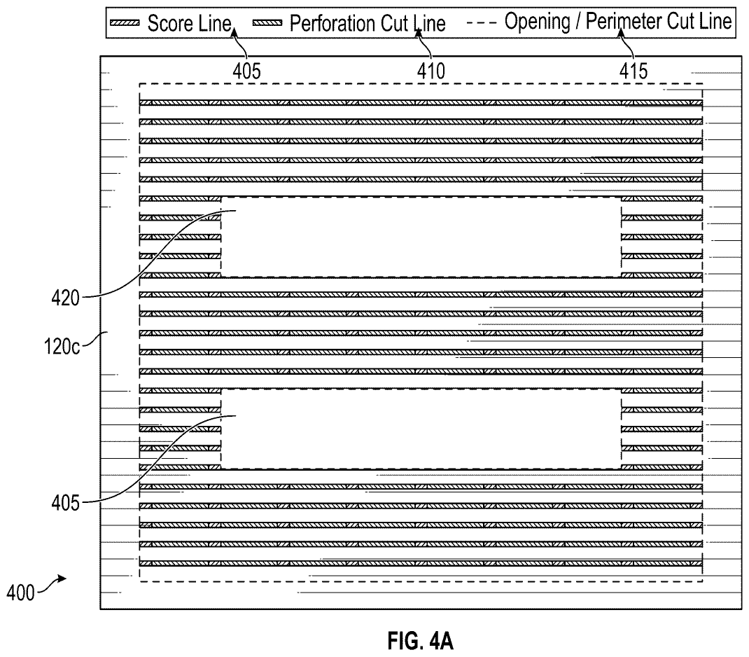

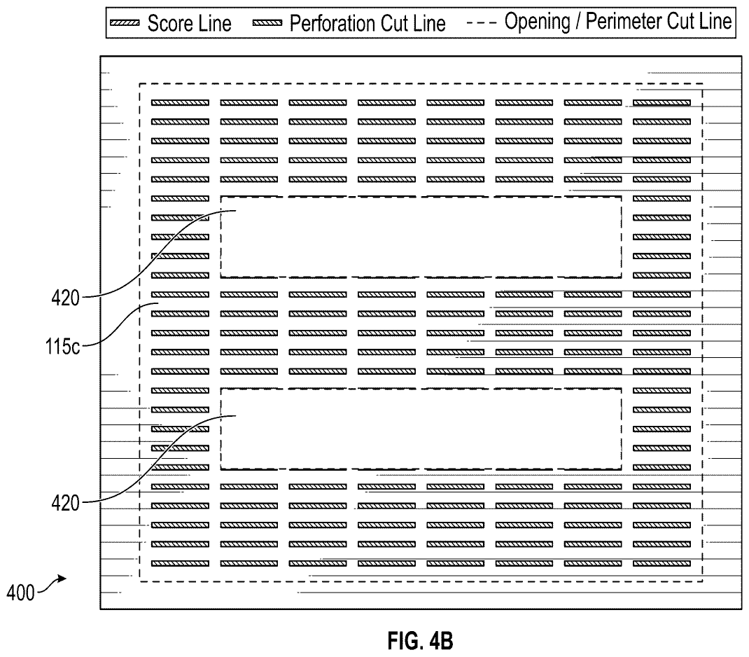

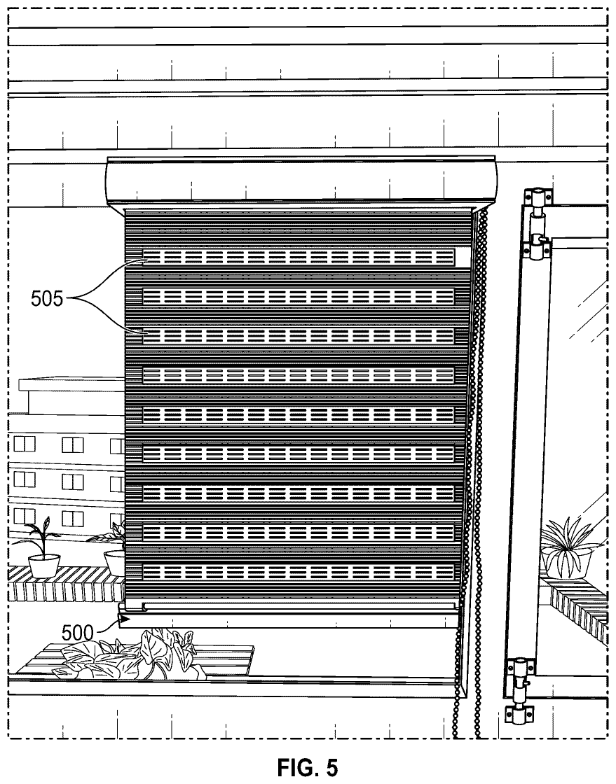

FIG. 4A is a front view of a window covering embodiment 400, in accordance with some aspects of the disclosure. For example, the front view of the embodiment 300 shown may show first the second layer 120c thereof. FIG. 4B is a back view of a window covering embodiment 400, in accordance with some aspects of the disclosure. For example, the front view of the embodiment 300 shown may show the first layer 115c thereof.

Window covering embodiment 400 may be similar in some aspects to window covering embodiment 300, but may include one or open bands 420. Similar to window covering embodiment 300 the window covering embodiment 400 may have score lines 405 and/or perforation lines 410, and may additionally have perimeter cut lines 415. At least some of such lines may illustrate one or more cutting and scoring pattern. For example, in the embodiment 400 shown, the perforation lines 410 may resemble dashed lines and indicate cuts penetrating all the way through the first layer 115c (e.g., of rigid material) and the second layer 120c (e.g., of fabric), thereby permitting light to shine therethrough at the line 215.

In between the perforation lines 410, may be scoring lines 405, where scoring occurred, cutting at least partially through the first layer 115c but not the second layer 120c, leaving the second layer 120c (e.g., fabric) on the back side intact at the scoring lines 405.

FIG. 5 illustrates a window covering embodiment 500 in an environment of use, in accordance with some aspects of the disclosure. As shown, the window covering embodiment 500 may be in a configuration where the open bands 505 are closed. This may occur, for example, where two sheets (or one sheet folded over to essentially create two sheets) have open bands 505 that are unaligned.

More specifically, in some embodiments, window covering embodiment 500 may include a sheet or screen folded over/layered one or more times composed of substantially opaque areas or bands and light/view permitting areas or bands 505, wherein the opaque areas are located between the light/view permitting areas and the light permitting areas/bands are mostly open/free from mesh, sheer fabric or other materials that inhibit the passage of light/view. In some examples, the ratio of the light permitting areas/bands 505 to the opaque areas/bands, (located between the light permitting areas/bands) may be roughly proportional to the number of times one long screen is layered, as roughly defined by the equation: Number of Layers—1=Light Permitting Band Width/Opaque Area Band Width.

In some examples, the embodiment 500 may be (1) relatively rigid and tough (difficult to deform, bend or fold and/or that regains its original shape when deformed) along the axis parallel to the opaque and light permitting areas/bands 505 and/or perpendicular to the direction of retraction; and (2) relatively flexible (easy to deform, bend, roll, fold, or similar) along the axis perpendicular to the opaque and light permitting areas/bands 505 and co-planar with the screen and/or parallel to the direction of retraction.

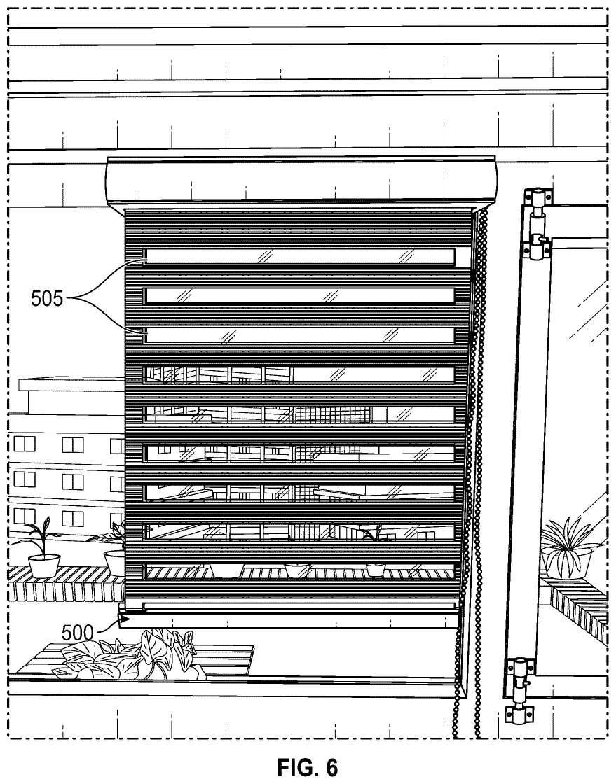

FIG. 6 illustrates the window covering embodiment 500 of FIG. 5 in an environment of use, in accordance with some aspects of the disclosure. As shown, the window covering embodiment 500 may be in a configuration where the open bands 505 are open. This may occur, for example, where two sheets (or one sheet folded over to essentially create two sheets) have open bands 505 that are aligned with one another. Some embodiments of window covering embodiment 500 may constitute a new type of banded shades. Pre-existing banded shades rarely if ever have open bands as in window covering embodiment 500, but rather have mesh filling in open spaces, which distorts views through such spaces. However, in part due to the window covering embodiment 500 use and configurations of rigid materials, open bands that provide viewing areas without distortions are possible.

In some embodiments, retraction or alignment of opaque and light permitting areas/bands 505 may utilize a rolling mechanism. For example, rolling window covering embodiment 500 and screen thereof around a cylinder(s), tube(s), or similar element(s) may adjust the relative position of opaque and light permitting areas/bands 505 in adjacent layers, thus partially or fully allowing or restricting the passage of light and view. Conversely, unrolling embodiment 500 or screen may adjust the relative position of opaque and light permitting areas/bands in adjacent layers. Some rolling mechanism embodiments may additionally include a mechanism of adjusting the spacing between screen layers along the axis perpendicular to the opaque and light permitting areas/bands and normal to the planes of the screen's layers, thus blocking and permitting the passage of solar radiation (as in some paralign shades).

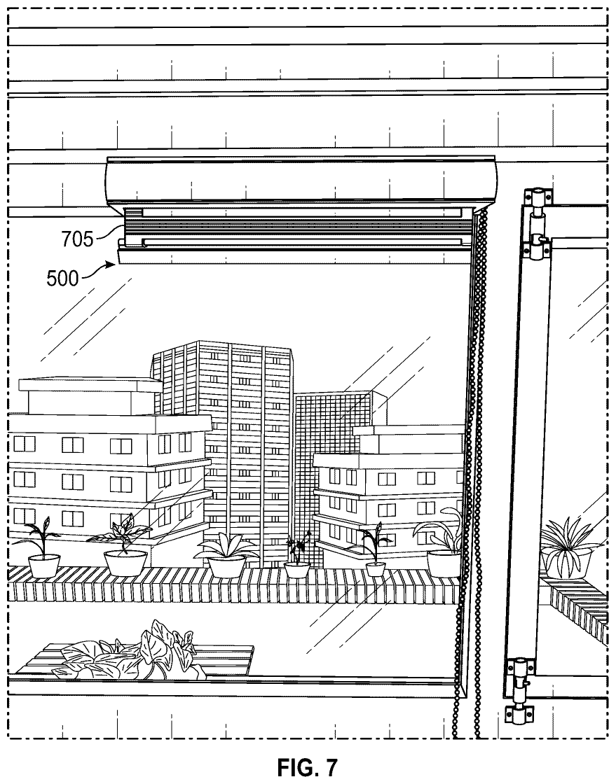

FIG. 7 illustrates the window covering embodiment 500 of FIG. 5 in an environment of use, in accordance with some aspects of the disclosure. Due in part to the lack of rigidity along the first or vertical axis 705—e.g., from a series of parallel strips separated by a plurality of functional joints—the window covering embodiment 500 may roll up, as shown in FIG. 7. For example, in between each two adjacent strips of the plurality of strips may be a joint configured to bend, so that the sheet of rigid material is rollable. In some examples, window covering embodiment 500 may roll up along an axis (e.g., vertically for a vertical axis, or roll up sideways along a horizontal axis).

Thus, in some embodiments, rolling window covering embodiment 500 and screen thereof around a cylinder(s), tube(s), or similar element(s) may also partially or fully remove. said screen from a window, door or other opening. Conversely, unrolling embodiment 500 or screen may partially or fully extends it into/over a window, door, or other opening.

Some embodiments may feature rolling bar/rod hanging structures, which in some examples may be positioned within the fold between two sheets (which may be one long sheet folder over in some examples) or screens. Some embodiments may also provide weight and/or tension to assist with the screen's layers laying flat and parallel to one another. Some embodiments with weights/weighted strips/weight screen sections, adhered, sewn, clipped, or otherwise connected to the sheet(s) or screen(s) may be at a regular or an irregular interval and provide weight or tension and help the screen's layers lay flat and parallel to one another.

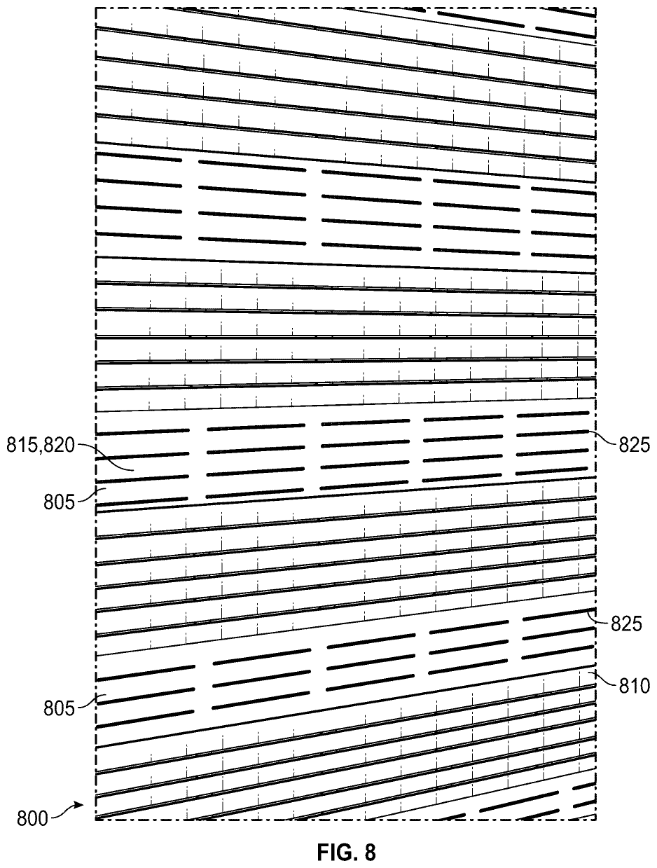

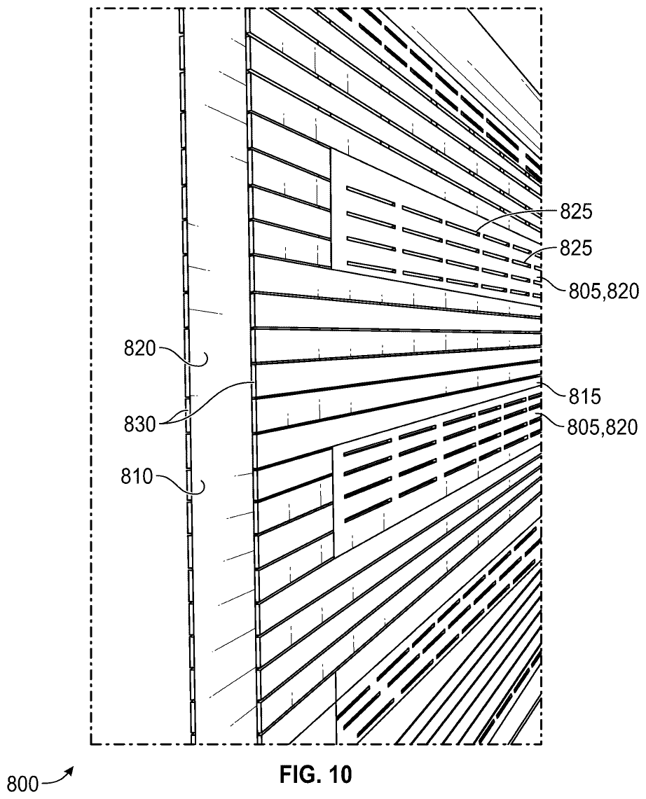

FIGS. 8 and 10 illustrate a window covering embodiment 800, in accordance with some aspects of the disclosure. FIG. 10 shows the window covering embodiment 800 at a greater perspective, to also how more clearly the second sheet 815. As shown, the window covering embodiment 800 may have a predetermined setting or configuration (e.g., a closed setting or configuration) where the open bands 805 do not allow viewing therethough. This may occur, for example, where two sheets 810, 815 (or one sheet folded over to essentially create two sheets) have open bands 805 that are unaligned (e.g., where the open bands 805 of one sheet 810 are aligned with the first layer 820 of the second sheet 815, which layer may be generally opaque in some embodiments). Nevertheless, in the embodiment 800 shown, some light might still pass through perforations 825 in the first layer 820 of the second sheet 815, and through the aligned open bands 805 of the first sheet 810. In some embodiments, the first layer 820 of the second sheet 815 may constitute a flexible material holding together the strips 830 or pieces of rigid material to form part of a relatively uniform second sheet 815 (or strips 830 of the combined first sheet 810 and second sheet 815).

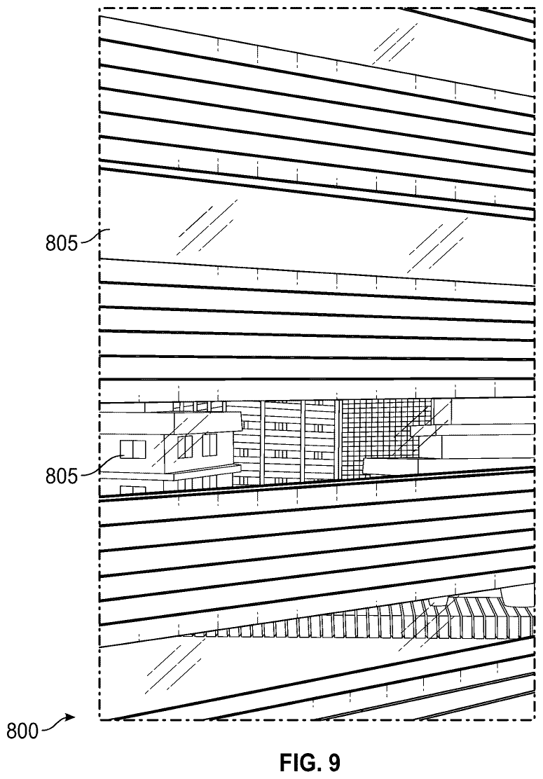

FIG. 9 illustrates a window covering embodiment 800, in accordance with some aspects of the disclosure. As shown, the window covering embodiment 800 may be in a configuration where the open bands 805 are open. This may occur, for example, where two sheets (or one sheet folded over to essentially create two sheets) have open bands 805 that are aligned with one another.

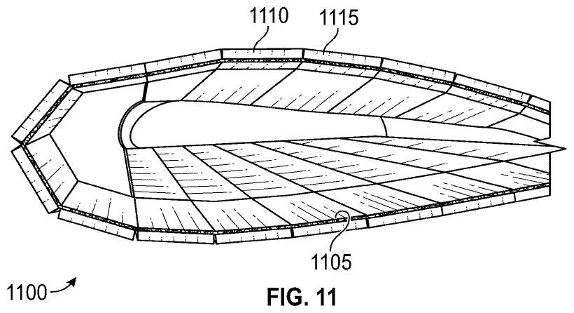

FIG. 11 illustrates a window covering embodiment 1100, in accordance with some aspects of the disclosure. The window covering embodiment 1100 may have a first layer 1105 of flexible material and a second layer 1110 of rigid strips 1115. The rigid strips 1115 may be aligned in parallel and because they are separate and distinct pieces may bend at functional joints between strip, causing the window covering embodiment 1100 to curve.

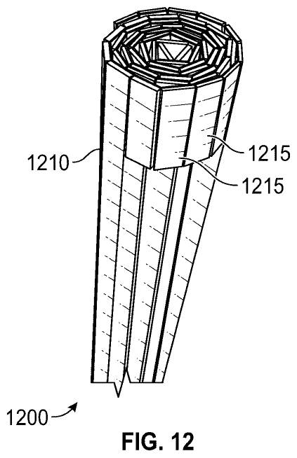

FIG. 12 illustrates a window covering embodiment 1200, in accordance with some aspects of the disclosure. Window covering embodiment 1200 may have a second layer 1210 that has rigid strips 1215. The rigid strips 1215 may be aligned in parallel. And in part because they are separate and distinct pieces, the rigid strips 1215 may bend at functional joints between strips, causing the window covering embodiment 1200 to roll up.

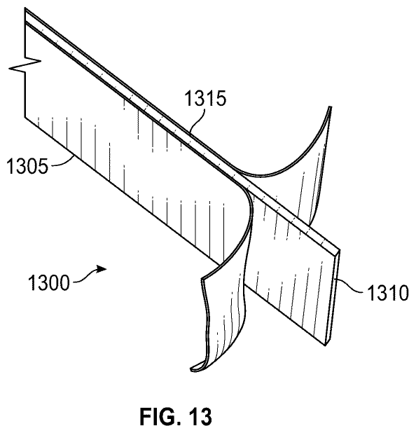

FIG. 13 illustrates a window covering embodiment 1300, in accordance with some aspects of the disclosure. Window covering embodiment 1300 may have a first layer 1305 of flexible material, a second layer 1310 of rigid material, and on the opposite side of the second layer 1310 as the first layer 1305, a third layer 1315 also of flexible material. The first layer 1305 and/or the third layer 1315 may be laminated to, adhered to, of bonded, to both faces of the second layer 1310. Two separate layers of flexible material 1305, 1315 in the window covering embodiment 1300 may provide structural and/or aesthetic benefits.

Whether having two layers of flexible material 1305, 1315, or one, or more than two, embodiments may have different opacity and translucency as well as varying dimensions. In some embodiments, opaque, translucent or sheer screen examples may be: (1) relatively rigid and tough (difficult to deform, bend or fold and/or that regain original shape when deformed) along the axis that runs perpendicular to the screen's direction of retraction and co-planar with the screens; and (2) relatively flexible (easy to deform, bend or fold) along the axis parallel to the direction of retraction.

Some embodiments described in this disclosure may have: (1) one or more layers of fabric; and (2) a rigid/tough sheet material, such as plastic sheet, reinforced composite sheet (e.g., GFRP, CFRP, or similar), metal sheet, wood sheet, one or more layers of wood, bamboo or similar veneer, microlaminated wood, bamboo, or similar material, cross-laminated wood, bamboo, or similar material or other rigid material. In some examples, one discrete or uniform set of laminated layers, screens or sheets may be less than 3 mm thick, and in some examples, less than 2.5 mm thick, and in some examples, less than 2 mm thick, and in some examples, less than 1.5 mm thick, and in some examples, less than 1 mm thick, and in some examples, less than 0.5 mm thick.

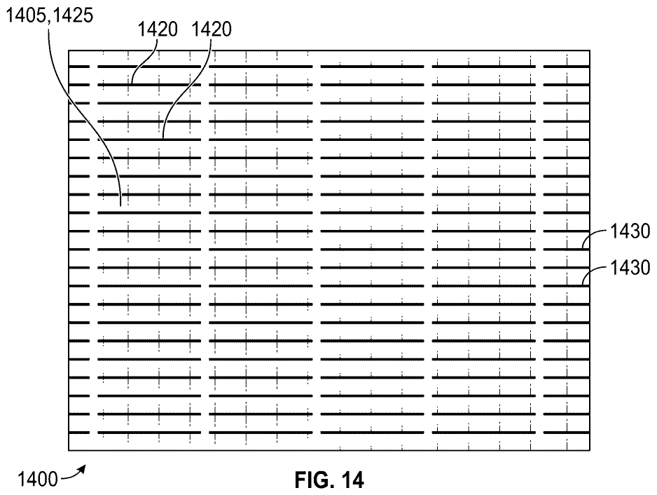

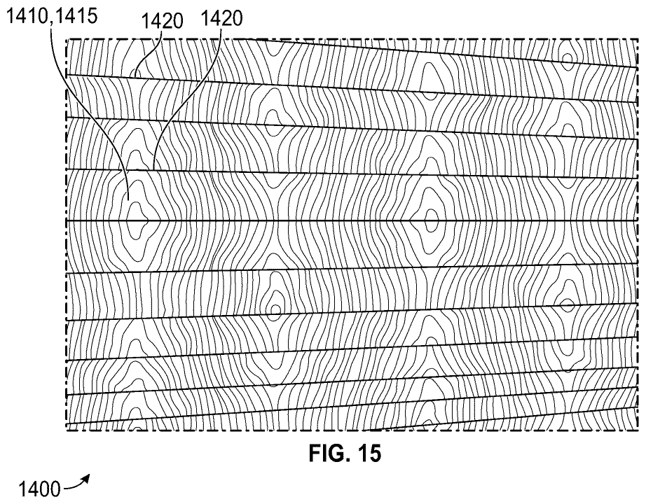

FIG. 14 illustrates a back side 1405 of a window covering embodiment 1400, in accordance with some aspects of the disclosure. FIG. 15 illustrates a front side 1410 of the window covering embodiment 1400, in accordance with some aspects of the disclosure.

The back side 1405 may have a first layer 1425, which in some embodiments may be made from fabric. The first layer 1425 may be set against, and attach to, a second layer 1415 of rigid material, such as bamboo micro-laminate. In some examples, the window covering embodiment 1400 may be a roller shade screen, which may be hung or installed against a window. Light may travel/shine through perforation lines 1420 of the second layer 1415 and the first layer 1425, which performation lines may indicate the locations of cuts passing all or most of the way through both the rigid material and the fabric. The first layer 1425 on the back side 1405 may have both perforations/cuts at performation lines 1420, as well as connections 1430 that correspond to scoring/breaking locations 1430.

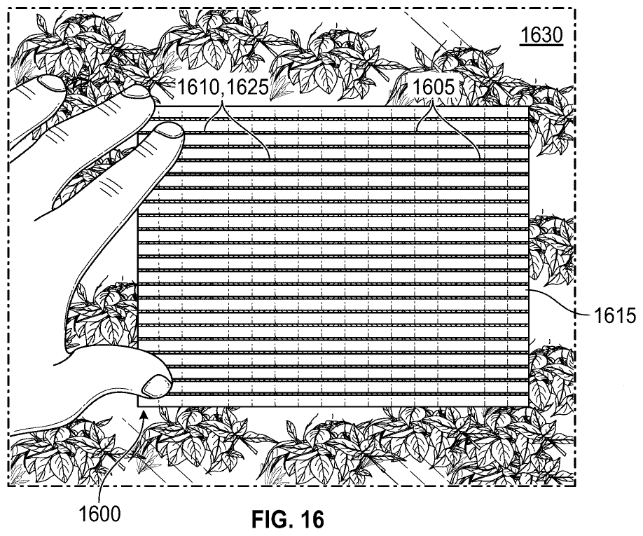

FIG. 16 illustrates a window covering embodiment 1600, in accordance with some aspects of the disclosure. Window covering embodiment 1600 features a pattern of periodic horizontal slits 1605, through which light may enter when the window covering embodiment 1600 is placed against a window 1630. The horizontal slits 1605 may resemble dashed lines and indicate cuts passing all the way through both the first layer 1625 (which may constitute material such as fabric) and a second layer 1615 (which may constitute rigid material). In between the horizontal strips 1605 are places scoring locations 1610 showing where the second layer 1615 was cut through and/or broken, thereby separating the rigid material into horizontal strips 1620, while leaving the first layer (e.g., the fabric) on the back side intact.

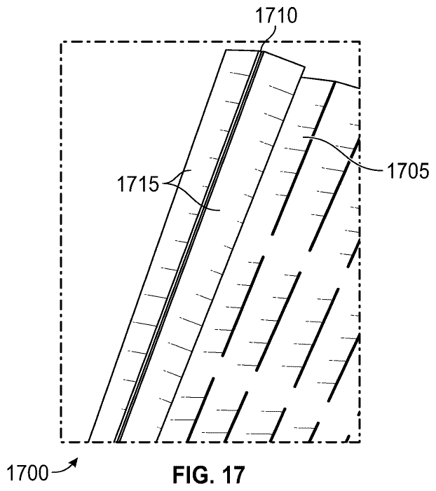

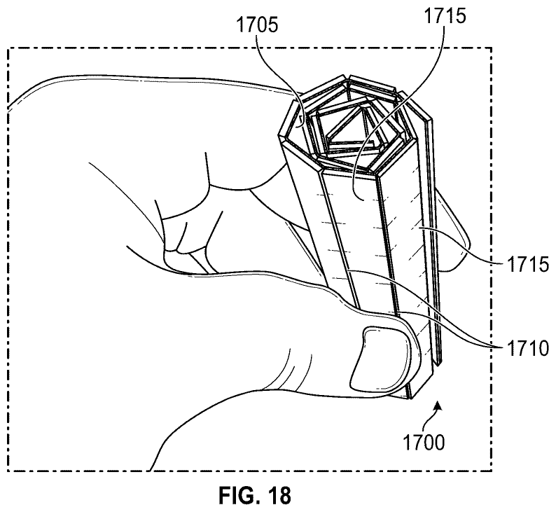

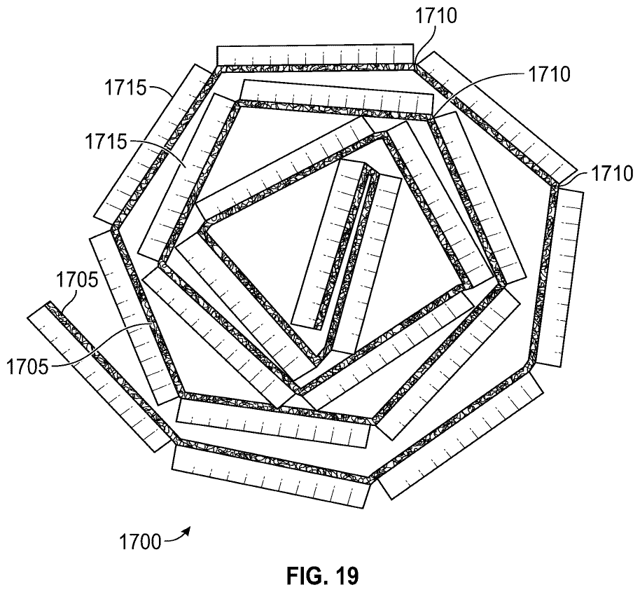

FIG. 17 illustrates a window covering embodiment 1700, in accordance with some aspects of the disclosure. FIG. 18 also illustrates the window covering embodiment 1700, in accordance with some aspects of the disclosure. FIG. 19 also illustrates the window covering embodiment 1700, in accordance with some aspects of the disclosure.

The window covering embodiment 1700 may features a plurality of rigid strips 1715 aligned in parallel as separate and distinct pieces. The rigid strips 1715 may nevertheless for a functionally cohesive until by all being attached to a first layer 1705 of flexible material and may bend at functional joints 1710 between strips 1715, causing window covering embodiment 1700 to first partially role up (as shown in FIG. 17), and then completely roll up (as shown in FIG. 18).

In some examples, such rolling or retracting of window covering embodiment 1700 (and a sheet thereof consisting of a combined first later 1705 and second layer including the plurality of rigid strips 1715) may occur around a cylinder(s), tube(s), or similar element(s). This may partially or fully removes window covering embodiment 1700 from a window, door, or other opening, allowing the passage of light and view. Conversely, wherein unrolling said window covering embodiment 1700 partially or fully extends it into/over a window, door, or other opening, may prevent the passage of light and view. In some examples, such rolling or retraction may entail the retracted window covering embodiment 1700 being compact and fitting within the depth of a window frame, or other space with limited depth.

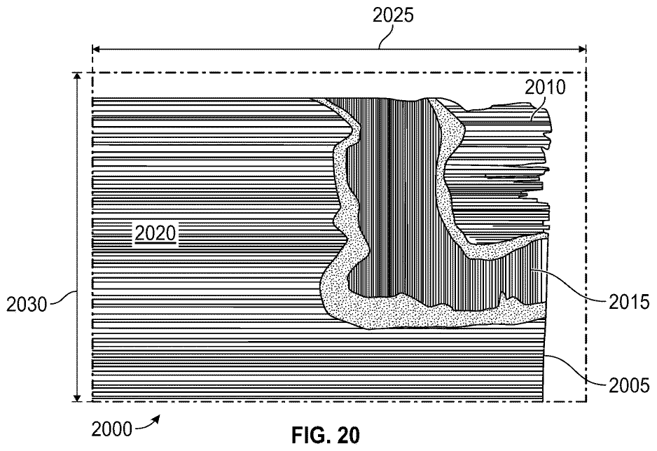

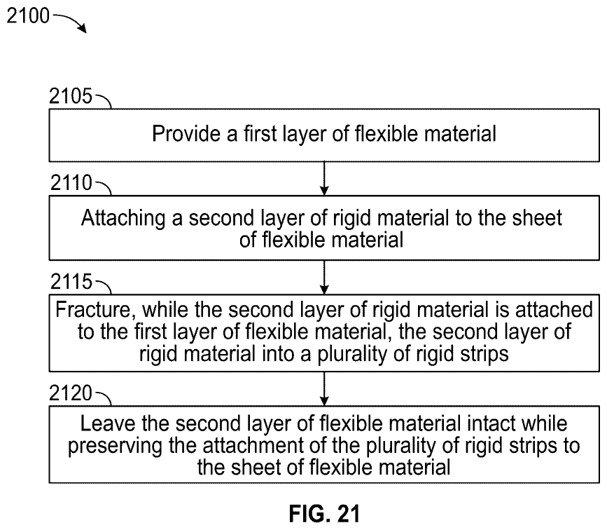

FIG. 20 illustrates a partically cutaway view of a window covering embodiment 2000, in accordance with some aspects of the disclosure. Window covering embodiment 2000 may have a rigid second layer 2005. In some embodiments, the second layer 2005 may be a particular type or particular types of layers of veneer made from wood, bamboo, or similar material selected for its/their specific properties. For example, in the embodiment 2000, the material of the second layer may include, and/or be at least partially bamboo. Bamboo may offer increased dimensional stability, so that, e.g., changes in humidity and heat may result in less warping.

Certain predetermined configurations of rigid material, and internal layers thereof, any also offer structural and other benefits tailored to a particular embodiment such as the window covering embodiment 2000. In some examples, the second layer of rigid material may itself have separate layers (or plies) of veneer that are cross-laminated so that each layer of veneer has grain that runs substantially perpendicular to the grain in adjacent layer(s) of veneer. In some examples, cross-lamination may increase the structural integrity and rigidity of the lamination, providing both a thin profile and horizontal rigidity necessary for the screens to remain flat when unrolled and to retract into a compact roll.

Accordingly, some examples of window covering embodiment 2000 may have rigid strips a second layer 2005 with a cellular structure, chemical composition, and/or patterns, etc., which match on either side of the joints separating them. For example, a wood grain in one strip (and pattern thereof) may line up with the wood grain (and pattern thereof) on the adjacent strip or strips, resulting in aesthetic benefits.

For example, as shown, window covering embodiment 2000 features a 3-ply bamboo microlaminate, using bamboo veneer with fleece backing. Each ply of the rigid second layer 2005 have a grain direction, which may be distinct from another ply. For example, a furthest-interior ply, a first ply 2010, may have a grain that runs horizontally along a horizontal axis 2025. In addition, a furthest-exterior ply, a third ply 2020, may have a grain that also runs horizontally along a horizontal axis 2025. In contrast, a second ply 2015, in between the first ply 2010, and the third ply 2020, may have a grain that runs vertically along a vertical axis 2030.

FIG. 21 is a flow diagram generally illustrating a method 2100 of creating a window covering article, in accordance with aspects of the disclosure. In some embodiments, such a method 2100 includes the step of providing 2105 a first layer of flexible material. In some embodiments, such a method 2100 includes attaching 2110 a second layer of rigid material to the sheet of flexible material.

In some examples, rigid material may include or consist of veneers made from wood, bamboo, or similar material. And in some examples, the flexible material may serve as a backing for the rigid material, and the flexible material may include or consist of nonwoven fleece, paper, cellulose, film, fabric, or similar material.

Examples of attaching may include laminating, bonding, adhering, fastening, or otherwise attaching fabric to one face of said rigid material using adhesive or other method of attachment and leaving the opposite face of the rigid material exposed. As described above with regard to FIG. 13, in some embodiments, more than one first layer of flexible material may be laminated or otherwise attached to two opposite faces of a second layer made of rigid material, using adhesive or other methods of attachment, so as to maintain the screen's structural symmetry, enhance the combined sheet or screen's resistance to bending/deformation along the axis that is co-planar with the screens and runs perpendicular to the screen's direction of retraction and/or to provide the desired color, texture, light reflection, and/or other properties on both sides of the screen. In some examples, said first layer(s) may be the same on both faces of the second layer (e.g., of rigid material, and in other examples may be different on either face of the second layer.

Some embodiments of method 2100 include, while the second layer of rigid material is attached to the first layer of flexible material, fracturing 2115 the second layer of rigid material into a plurality of rigid strips but leaving 2120 the second layer of flexible material intact while preserving the attachment of the plurality of rigid strips to the sheet of flexible material, to create the window covering article.

In some method 2100 embodiments, the fracturing includes fracturing the second layer of rigid material into a plurality of rigid strips that are parallel-aligned to each other. In some method 900 embodiments, the attaching the second layer of rigid material to the first layer of flexible material results in a sheet of materials with two layers. And in such embodiments, the fracturing may include at least one of scoring or cutting entirely through the sheet of materials.

In some such embodiments of method 2100, the pre-determined pattern may leave at least some light-permitting areas through which light passes through at least some areas of the sheet of flexible material corresponding to the at least some light-permitting areas. In some method 2100 embodiments, the attaching the second layer of rigid material to the first layer of flexible material may include adhering the second layer of rigid material to the first layer of flexible material.

Some embodiments of method 2100 include cutting at least one of the second layer of rigid material and the first layer of flexible material in a pre-determined pattern. In some examples, the first layer and/or the second layer may be made of materials that can be die cut/scored, knife cut/scored (including by computer numeric control knife cutting), laser cut/scored waterjet cut/scored, milled, routed, slit, or otherwise cut/scored. In some examples, said first layer and the second layer may be made from fabric and rigid material, respectively, which may be resistant to UV degradation, coated with a UV resistant material, or otherwise protected from UV degradation.

In some example, material(s) may be cut, scored, perforated or otherwise modified to maintain rigidity along the axis perpendicular to the direction of retraction and coplanar with the screens, and flexibility along the axis that runs parallel to the direction of retraction. For examples including a layer of flexible material on one face of a second layer, the cutting, scoring, perforation, or modification may serve to separate the rigid material into distinct strips or bands that may run perpendicular to the direction of retraction and coplanar with the screen. Alternatively, in some embodiments including first layers on opposite faces of the second layer, the cutting, scoring, perforation, or modification may serve to separate the rigid material and one layer of fabric (only) into distinct strips or bands that run perpendicular to the direction of retraction and co-planar with the screen. In some examples, cutting, scoring, perforation, or modification may involve a minimum of one layer of fabric remaining wholly or partially uncut and forming a continuous or partially continuous sheet that holds the distinct strips of rigid material, and a combined sheet or screen of layers as a whole, together.

In some embodiments, cutting, scoring, perforation or modification of rigid materials may involve the creation of control joints/weakened areas within the rigid material. This may facilitate the breaking, severing, or separation of distinct strips of rigid material following the initial cutting/scoring/perforation process, thereby increasing manufacturing tolerances related to scoring depth. In some examples of multiple internal layers to the second layer of rigid wood or bamboo veneer material (as described with regard to FIG. 20), scoring may run parallel to the grain of the bottom or back layer of veneer—the layer of the veneer that is attached to the first layer (e.g., of fabric) on the back of a combined sheet (of first and second layers). In some examples, scoring may substantially cut through the top layer(s) of veneer, but may not cut all the way through bottom layer of veneer or the fabric on the back of the sheet/screen, and to facilitate breaking the second layer (and e.g., the top layer(s) of veneer thereof) parallel to the grain after cutting.

In some process or method examples, cutting, scoring, perforation may include or involve some or all of (and may not necessarily be limited to) the following steps: (1) perforating/cutting through the sheet or screen in dashed lines running perpendicular to the direction of retraction and co-planar with the screen; (2) scoring (partially cutting through) the screen at a depth that does not penetrate the bottom or back layer of fabric in the spaces that are collinear with and in between the perforations/through-cuts running perpendicular to the direction of retraction and coplanar with the screen; and (3) if/when said scoring depth does not fully penetrate said rigid material, breaking, severing, or otherwise separating the remaining rigid material following the scoring process by bending, flexing, or other separation process, so as to create distinct strips of rigid material that remain connected by the fabric sheet on one side (the back or bottom face of the screen). In some examples, areas of the first layer (e.g., a fabric sheet) that remain intact may correspond to the scored/partially cut-through portions of the sheet or screen.

Some process embodiments may also include: securing a flexible sheet of material to a rigid sheet of material; after the securing, at least one of cutting, scoring, or breaking the rigid sheet of material at predetermined first locations to create separate strips of the rigid sheet of material; and refraining from breaking, cutting, or scoring the flexible sheet of material or portions of the flexible sheet of material at second locations of the flexible sheet aligned with the first locations of the rigid sheet of material, so that the flexible sheet holds together the separate strips of the rigid material. In some embodiments, the sheet of flexible material aligned with, or behind, the scored first locations of the rigid sheet of material may remain intact. In some examples, the cutting, scoring, and/or breaking of the rigid sheet of material may extend across an entire width of the rigid sheet of material (e.g., screen).

In some process embodiments, the first portion of the rigid sheet of materials may include one or more layers of wood or bamboo veneer, fibreglass, plastic sheet, or the like, or any combination thereof. In some process embodiments, at least one of the cutting or scoring may be performed using at least one of various types of die cutting such as rotary die cutting, flatbed die cutting(including flatbed roller die cutting), and at least one of various types of cutting rules and/or dies such as steel rule dies (including perforating rule dies), flexible dies or magnetic dies, or the like. In some process embodiments, at least one of the cutting or scoring may be performed using at least one of knife cutter, laser cutter, waterjet cutter, milling machine, router, saw, slitter or other cutter, or the like.

In some embodiments, the scoring process precedes the cutting process. In some embodiments, the cutting process precedes the scoring process. In some embodiments, the cutting process and the scoring process take place in a staggered or partially staggered sequence. In some embodiments, the scoring process and the cutting process take place concurrently, as in a flat-bed or rotary die cutting process. Some embodiments may omit or exclude a cutting step (and only involve scoring). Some embodiments may include the step of breaking rigid material in the locations where it has been scored. Some embodiments may also include the step of cutting a sheet or screen at its perimeter, to create its overall size/dimensions (which in some examples may be conformed to the size/dimensions of a window). Some method embodiments for making, manufacturing, or fabricating window coverings (e.g., for banded shades) may also include the step of cutting openings in the screen to create transparent bands/openings.

Some method embodiments may involve manual, semi-automated, automated, and/or digitally controlled process steps. Some steps may involve, in some examples, die cutting/scoring, steel rule die cutting/scoring, die cutting/scoring with a perforating rule die (e.g., similar to an EZ score perforating rule, and/or combination cut and cut rule), rotary die cutting/scoring, flatbed die cutting/scoring (including flatbedroller die cutting/scoring), flexible die cutting/scoring, magnetic die cutting/scoring, knife cutting/scoring (e.g., CNC), flash cutting/scoring, laser cutting/scoring, waterjet cutting/scoring, milling, routing, sawing, slitting, or other similar process step. In some method embodiments, die cutting may occur or be to only one side of material (e.g., a sheet).

References herein to particular shades such as roller and banded shades, and to improvement thereof, are exemplary in purpose. And aspects of window covering embodiments and methods of creating such described herein are adaptable and/or applicable to other types of window coverings (e.g., roman shades, vertical blinds).

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, articles, and systems. This applies to all embodiments of this application including, but not limited to, steps in disclosed methods. Thus, if there are a variety of additional steps that may be performed (e.g., based on descriptions of article embodiments herein) it is understood that each of these additional steps may be performed with any specific embodiment or combination of embodiments of the disclosed methods.

These and other features, and characteristics of the present technology, as well as the methods of operation and functions of the related elements of structure and the combination of parts and economies of manufacture, will become more apparent upon consideration of the description herein and the appended claims with reference to the accompanying drawings, all of which form a part of this specification, wherein reference numerals designate corresponding parts in the various figures. It is to be expressly understood, however, that the drawings are for the purpose of illustration and description only and are not intended as a definition of the limits of the disclosure.

1. A window covering article for preventing at least some light from passing through a window, comprising:
a sheet of flexible material extending along a first axis and a second axis and conformed to the shape of a window so as to cover at least a portion of the window, wherein the window covering article is flexible along the first axis and inflexible along the second axis;
a plurality of rigid strips, wherein each of the plurality of rigid strips is adjacent to at least one other of the plurality of rigid strips and inflexible along the second axis,
wherein the sheet of flexible material overlaps the plurality of rigid strips; and
a plurality of perforations between at least two adjacent rigid strips of the plurality of rigid strips,
wherein the at least two adjacent rigid strips are adjacent along the first axis, and
wherein the plurality of perforations extend between the at least two rigid strips and through the flexible material.

2. The window covering article of claim 1, wherein the plurality of perforations are at least one of light-permitting and slits.

3. The window covering article of claim 1 wherein the plurality of rigid strips are attached to the sheet of flexible material, and wherein at least a portion of some of the plurality of rigid strips is not adjoining to any of the other of the plurality of rigid strips.

4. The window covering article of claim 3, wherein each of the plurality of rigid strips has a length and a width, wherein the length is greater than the width.

5. The window covering article of claim 4, wherein the plurality of strips are parallel to one another along the length of each of the plurality of rigid strips.

6. The window covering article of claim 5, wherein the first axis is perpendicular to the second axis, and the plurality of strips are parallel to one another along the second axis.

7. The window covering article of claim 3, wherein the first axis corresponds to a vertical axis and the second axis corresponds to a horizontal axis, and wherein the window covering article is rollable together along the first axis.

8. The window covering article of claim 6, further comprising:
a plurality of joints, wherein at least one of the plurality of joints is between each of the adjacent plurality of rigid strips, wherein each of the plurality of joints is bendable so that the window covering article rolls together along the first axis,
wherein each of the plurality of joints is adjoining to two adjacent rigid strips of the plurality of rigid strips, and
wherein the width of each of the plurality of rigid strips, including the at least two rigid strips between which the plurality of perforations extend, is substantially greater than a width of each of the plurality of joints.

9. The window covering article of claim 2, wherein the sheet of flexible material is at least one of transparent, semitransparent, translucent, or opaque.

10. The window covering article of claim 2, wherein the plurality of rigid strips and the sheet of flexible material together form a screen, and further comprising:
one or more light-permitting areas in the screen.

11. The window covering article of claim 10, wherein the plurality of rigid strips comprises a first plurality of rigid strips, and the sheet of flexible material comprises a first sheet of flexible material, and the screen comprises a first screen, and further comprising:
a second screen comprising a second sheet of flexible material overlapping a second plurality of rigid strips, wherein the second screen comprises one or more light-permitting areas, and wherein the window covering article is configured to align the first screen in parallel with the second screen.

12. The window covering article of claim 11, configured to align the one or more light-permitting areas of the first screen with the one or more light-permitting areas of the second screen to increase light through the aligned one or more light-permitting areas of the first screen and one or more light-permitting areas of the second screen; and
configured to dis-align the one or more light-permitting areas of the first screen with the one or more light-permitting areas of the second screen to decrease light through the aligned one or more light-permitting areas of the first screen and one or more light-permitting areas of the second screen.

13. The window covering article of claim 11, wherein the first screen and the second screen comprise separate portions of the same screen, folded over.

14. A method of creating a window covering article, comprising:
providing a first layer of flexible material;
attaching a second layer of rigid material to the first layer of flexible material;
while the second layer of rigid material is attached to the first layer of flexible material, creating a plurality of perforations between at least two intended adjacent rigid strips of the plurality of rigid strips, wherein the plurality of perforations extend between the at least two intended adjacent rigid strips and through the first layer of flexible material; and
fracturing, based at least in part on the creating, the second layer of rigid material into a plurality of rigid strips, including fracturing at least two adjacent strips of the plurality of rigid strips associated with the at least two intended adjacent rigid strips, but leaving the second layer of flexible material intact other than the plurality of perforations, while preserving the attachment of the plurality of rigid strips to the sheet of flexible material, to create the window covering article.

15. The method of claim 14, wherein the fracturing comprises fracturing the second layer of rigid material into a plurality of rigid strips that are parallel-aligned to each other.

16. The method of claim 14, wherein the attaching the second layer of rigid material to the first layer of flexible material results in a sheet of materials with two layers, and wherein the fracturing comprises:
at least one of scoring or cutting entirely through the sheet of materials,
wherein at least some of the plurality of perforations are at least one of light-permitting and slits.

17. The method of claim 16, further comprising:
cutting at least one of the second layer of rigid material and the first layer of flexible material in a pre-determined pattern.

18. The method of claim 17, wherein the pre-determined pattern leaves at least some light-permitting areas through which light passes through at least some areas of the sheet of materials corresponding to the at least some light-permitting areas.

19. The method of claim 14, wherein the attaching the second layer of rigid material to the first layer of flexible material comprises:
adhering the second layer of rigid material to the first layer of flexible material.

20. The method of claim 14, further comprising conforming the window covering article to the dimensions of a window.
